(19) United States
(12) Patent Application Publication
(10) Pub. No.: US 2021/0174076 A1
(43) Pub. Date: Jun. 10, 2021

(54) METHOD FOR BUILDING AN AI TRAINING SET

(71) Applicant: Aistemos Limited, London (GB)

(72) Inventors: Charles Fisher, London (GB); Stephen Harris, London (GB); David Challis, London (GB)

(21) Appl. No.: 17/101,731

(22) Filed: Nov. 23, 2020

(30) Foreign Application Priority Data
Dec. 6, 2019 (GB) 1917918.3

(51) Int. Cl. G06K 9/00; G06K 9/62; G06N 20/00

(52) U.S. Cl. CPC G06K 9/00456; G06N 20/00; G06K 9/6228; G06K 9/6268

(57) ABSTRACT

A computer implemented method of building a training set for training an AI program for document classification is provided. The method comprises, in relation to a first training set comprising a set of documents classified as positive, and therefore of interest to a user, or negative, and therefore not of interest to the user, the steps of: receiving a selection of a search algorithm for obtaining further documents; obtaining, based upon the selected algorithm, a plurality of documents; presenting a selected subset of the documents to the user; receiving user input, wherein the user input is a user classification of whether one or more of the presented documents are positive or negative; adding the user classified documents to the training set to create a second training set; and repeating, until the training set is considered complete, the above steps, wherein the second training set is then used as the first training set.

### TECHNICAL FIELD

The invention relates to a method for building a training set to be used to train an AI program for document classification.

### BACKGROUND

Artificial intelligence (AI) computer programs are becoming more and more prevalent throughout society. One reason for this is that AI programs can be trained to classify objects. For example, they can be trained to classify documents or images. Once trained to classify objects, an AI program can sift through many hundreds or thousands of unclassified objects and classify them at a much greater rate than a human counterpart could manage.

In order that the AI program is useful, however, it must be able to classify objects accurately. That is, it must have a low error rate, including errors of assigning an object to an incorrect category (“false positives”) and overlooking an object that should have been assigned to a category (“false negatives”). To classify objects accurately, an AI program must first be “trained” using a training set.

A training set is a set of objects that have already been accurately classified, for example by one or more humans, that can be then used to train an AI computer program. Typically, the training set will have one or more classes that the AI program is to be trained to classify objects within. The AI program is programmed to recognise features of the objects that have been classified and to learn how to classify a new object (an object not already in the training set) based upon similarities and differences between the features of the new object and the features of the objects in the different classes in the training set.

Usually, a training set will be required to contain many tens, hundreds, thousands or indeed even more objects in order to adequately train an AI program so that it can classify new objects satisfactorily to a given standard, as required by the user of the AI program. It is important that these documents cover a broad spread of the potential objects that an AI program may encounter and be asked to classify. The training set should include objects in each class into which it may be required to classify an object, as well as potentially an “other” or “not of interest” class representing everything that does not fall within another class. In binary classification, a training set will comprise two classes, for example a class of “Positives” and a class of “Negatives”. In the case of three classes, the classes may be labelled “Red”, “Green” and “Blue”, for example. Furthermore, the training set objects must be representative of each class so that the AI program can correctly recognise any object that should fall within the class.

Building such a training set can be very time consuming and costly for someone wishing to train an AI program. This is because each document in the training set must first be accurately classified as explained above. Given that training sets may require many thousands of objects in order to train the AI program to an adequate standard, it can take a substantial amount of time and effort for a human to classify the required number of objects. In addition, it requires a high level of specialist knowledge in order to make sure that the training set has the required coverage of objects in the different classes. That is, it can require an expert data scientist to ensure that the training set is representative of each class in order for the AI program to be properly trained. Such time and cost requirements can be prohibitive to many who would like to utilise an AI program for object classification, thus greatly reducing AI program utilisation, hampering the technological and economic benefits that would otherwise follow.

### SUMMARY OF THE INVENTION

The invention is defined by the independent claims, to which the reader is now directed. Preferred or advantageous embodiments are set out in the dependent claims below.

Embodiments of the invention overcome the above described problems associated with creating a training set by providing a user input method by which a training set can be built that is suitable for training an AI program, improving the accuracy of the resulting trained AI program in performing classifications.

According to a first embodiment of the invention a computer implemented method of building a training set for an AI program for document classification is provided. The method comprises, in relation to a first training set comprising a set of documents classified as positive, and therefore assigned to a given category (which may be of interest to a user), or negative, and therefore not assigned to the given category (which therefore may not be of interest to the user), the steps of: receiving a selection of a search algorithm for obtaining further documents; obtaining, based upon the selected algorithm, a plurality of documents; presenting a selected subset of the documents to the user; receiving user input, wherein the user input is a user classification of whether one or more of the presented documents are positive or negative; adding the user classified documents to the training set to create a second training set; and repeating, until the training set is considered complete, the above steps, wherein the second training set is then used as the first training set.

Optionally, the step of receiving a selection of a search algorithm for obtaining further documents comprises the step of automatically selecting a search algorithm from a plurality of preset search algorithms.

Automatically selecting a search algorithm from a plurality of preset search algorithms allows a user to be guided in the creation of the training set. This allows a more efficient method for creation of a training set, and a better training set capable of more accurately training an AI program.

Optionally, the search algorithm is automatically selected from a plurality of preset search algorithms based on the composition of the first training set.

By taking into account the composition of the first training set, the efficiency by which the training set is built is greatly increased as the method can be optimised by selecting a search algorithm that will help to expand the training set in the required manner.

Optionally, automatically selecting, based upon the composition of the first training set, an algorithm from a plurality of preset search algorithms comprises: determining the number of documents in the training set classified as positive and the number of documents in the training set classified as negative in the training set; and selecting a search algorithm from a plurality of preset search algorithms based upon the number of documents in the training set classified as positive and the number of documents in the training set classified as negative.

Taking into account the number of documents in the training set classified as positive and the number classified as negative and selecting a search algorithm accordingly further help to increase the efficiency by which a training set can be built and the accuracy of an AI trained on the resultant training set. This is because fewer documents need to be included in the training set, as the training set can be built up by searching for the required documents to improve it in the most efficient manner, by taking into account the number of documents in the training set already classified as positive or negative.

Optionally, selecting a search algorithm from a plurality of preset search algorithms based upon the number of documents in the training set classified as positive and the number of documents in the training set classified as negative comprises: selecting, if the number of documents classified as positive in the training set is greater than the number of documents classified as negative in the training set, a search algorithm predetermined to return documents expected to be classified as negative; or selecting, if the number of documents classified as positive in the training set is less than the number of documents classified as negative in the training set, a search algorithm predetermined to return documents expected to be classified as positive.

Selecting a search algorithm that is predetermined to return documents likely to be classified as either positive or negative, depending upon whether there are more documents classified as negative or positive respectively already in the training set, again means that a training set can be built more efficiently because potential deficiencies in the training set are identified and an appropriate algorithm selected automatically that is most likely to rectify any potential deficiencies in the training set.

Optionally, a search algorithm is predetermined to return documents expected to be classified as negative or positive based upon a predetermined categorisation of the search algorithm.

By having a search algorithm have a predetermined categorisation as to whether they are likely to return documents expected to be classified as positive or negative the most appropriate search algorithm for improving the training set, based on the current state of the training set, can be automatically selected.

Optionally, a search algorithm is predetermined to return documents expected to be classified as negative or positive based upon historical data indicating whether the search algorithm returns more documents that were classified as negative or positive.

Utilising historical data indicating whether a search algorithm returns more documents that were classified as negative or positive allows the search algorithm that will most efficiently improve the training set to be automatically selected.

Optionally, the search algorithm is automatically selected from a plurality of preset search algorithms according to a predefined sequence of the plurality of preset search algorithms.

Selecting the search algorithm according to a predefined sequence of the plurality of preset search algorithms can be advantageous because it means that, over multiple iterations of the method, each algorithm is applied meaning that a broad spread of documents are considered for inclusion in the training set, meaning that an AI program trained according to the training set is more accurate.

Optionally, the method further comprises, between the step of obtaining, based upon the selected algorithm, a plurality of documents and the step of presenting a selected subset of the documents to the user, the step of: classifying, by the AI program for document classification, the plurality of documents to provide each document with an AI classification score indicating whether the AI program classifies each document as positive or negative, the AI classification score being a numerical score within a numerical range having an upper and a lower bound.

Providing an AI classification score provides information to the user as to how well the AI classifier program is being trained, which in turn provides information as to how good the training set is. By providing such AI classification scores, the user can easily identify types of documents that should be added to the training set, or that they AI program is not correctly classifying.

Optionally, the selected subset of the documents presented to the user comprise documents assigned a range of AI classification scores by the AI program, the range of scores being distributed across substantially the entire numerical range of the AI classification score.

By presenting the user with a range of AI classification scores, the user is provided information allowing them to see how well the AI classifier is working for a variety of documents and to ensure that the training set is suitably diverse.

Optionally, the selected subset of the documents presented to the user comprise documents assigned an AI classification score within a predetermined range indicating that the AI program is not confident in its classification of whether the document is positive or negative.

By presenting the user with documents assigned an AI classification score within a predetermined range indicating that the AI program is not confident in its classification of the documents, only documents that would usefully expand the training set are presented to the user, increasing the efficiency of creating a completed training set.

Optionally, at least one of the plurality of preset search algorithms is an algorithm configured to return documents based upon one or more of the text of the documents in the training set, classification codes of documents in the training set, or citations within or citations of the documents in the training set.

By using the text, classification codes, or citations within or of documents in the training set, appropriate documents can be found by the preset search algorithms to allow the efficient expansion of the training set.

Optionally, at least one of the plurality of preset search algorithms is an algorithm configured to return documents based upon synonyms of words that the AI program has determined are relevant.

Looking for synonyms can be advantageous for a search algorithm because it allows documents in separate fields, with different terminology, to be identified, and makes the algorithms more likely to find appropriate documents to allow the training set to be efficiently built.

Optionally, words are determined to be relevant by the AI program if they occur frequently in documents classified by the user as positive but infrequently in documents classified as negative by the user.

Having the AI program determine words to be relevant based on the frequency with which they are classified as positive or negative in the training set allows the AI program to utilise information from previously classified documents to efficiently help efficiently expand the training set.

Optionally, at least one of the plurality of preset search algorithms is an algorithm configured to return documents that are similar to documents that have been classified differently both by the user and the AI program.

Documents that have been classified differently by the user and the AI program indicate areas where the AI program is in need of improvement, which in turn indicates that the training set should be expanded. By returning documents similar to those that have been classified differently, the training set can be expanded efficiently by including these documents so that the AI program can learn how to classify that type of document correctly in the future.

Optionally, at least one of the plurality of preset search algorithms is an algorithm configured to return documents that are associated with classification codes that are frequently associated with documents classified as positive within the training set.

By returning documents associated with classification codes that are frequently associated with documents classified as positive within the training set, it is possible to efficiently expand the training set, in particular by increasing the number of documents classified as positive.

Optionally, at least one of the plurality of preset search algorithms is an algorithm configured to return documents that are associated with classification codes that are infrequently associated with documents classified as positive within the training set.

Such an algorithm that returns documents with classification codes that are infrequently associated with documents classified as positive within the training set can be particularly advantageous for defining the “edge” of a technology, and for finding documents that the AI program may struggle to classify. By adding such documents to the training set, the training set can be efficiently expanded without adding many unnecessary documents.

Optionally, the training set is considered complete either after a predetermined number iterations or when user input is received indicating that the training set is considered complete.

Optionally, the steps of the method take place in a single user interface environment.

By having the method take place in a single user interface environment, the ease and efficiency by which a user can be guided to create a training set is increased.

Optionally, the number of documents classified as positive and the number of documents classified as negative in the first training set are displayed to the user.

Displaying the number of documents classified as positive and negative in the training set allows the user to efficiently determine the composition of the training set and to see how the training set should be expanded.

According to a second embodiment of the invention, a computer program is provided comprising instructions which when implemented upon a computer device cause the computer device to carry out the method of the first embodiment of the invention.

According to a third embodiment of the invention, a device is provided comprising a memory, wherein the memory has stored upon it a computer program according to the second embodiment of the invention.

According to a fourth embodiment of the invention, a training set for an AI program for document classification is provided, built using the method of the of the first embodiment of the invention.

According to a fifth embodiment of the invention, a device is provided comprising a memory, wherein the memory has stored upon it a training set according to the fourth embodiment of the invention.

According to a sixth embodiment of the invention, an AI program for document classification is provided, the AI program being trained using a training set built using the method of the first embodiment of the invention.

According to a seventh embodiment of the invention, a device is provided comprising a memory, wherein the memory has stored upon it an AI program according to the sixth embodiment of the invention.

### BRIEF DESCRIPTION OF THE DRAWINGS

FIG. 1 illustrates a training set according to an aspect of the present invention.

FIG. 2 illustrates a computer implemented method according to an aspect of the present invention.

FIG. 3 illustrates a computer implemented method according to another aspect of the present invention.

FIG. 4 illustrates a user interface environment in which the method of FIG. 2 and/or FIG. 3 may be performed.

### DETAILED DESCRIPTION

To train an AI program to accurately and reliably classify objects into certain classes, the AI program must be “trained” to recognise each class of object. The training of an AI is done using what is known as a training set. The training set contains examples of objects that belong in each class, and allow the AI program to identify features that indicate an object belongs in a given class.

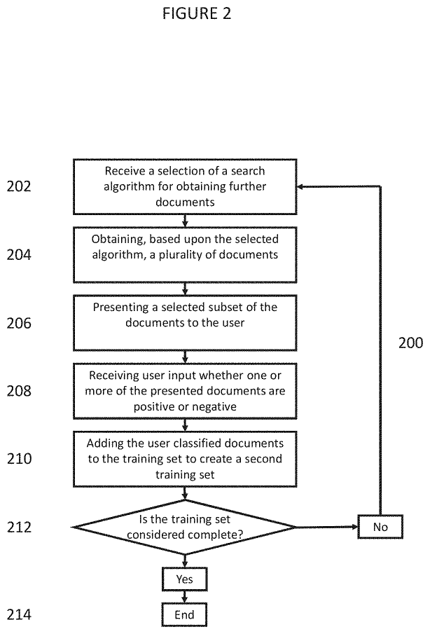

FIG. 2 illustrates a method 200 of building a training set for an AI program for document classification. In this embodiment, the AI program is to be trained to identify documents of interest to a user. The method begins with a first, initial, training set comprising a set of documents classified as positive, and therefore falling within the desired category of interest to a user, or negative, and therefore not falling within the desired category and not of interest to the user. The method comprises a number of steps.

In the first step 202, a selection of a search algorithm for obtaining further documents is received.

In the second step 204, a plurality of documents is obtained based upon the selected algorithm.

In the third step 206, a selected subset of the documents are presented to the user.

In the fourth step 208, user input is received as to whether one or more of the presented documents are positive or negative.

In the fifth step 210, the user classified documents are added to the training set to create a second training set.

In the sixth step 212, it is determined whether the training set is considered complete. If, in step 212, it is determined that the training set is not considered complete, the method returns to step 202 and repeats a further iteration of method 200, using the second training set of the first iteration as the first training set of the second iteration. If, in step 212, it is determined that the training set is considered complete, then the method ends at step 214.

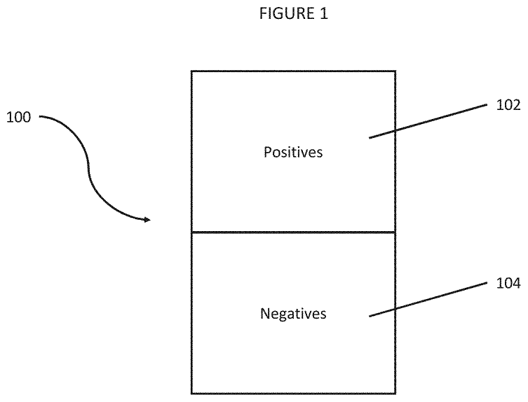

FIG. 1 illustrates a schematic representation of training set 100 according to an aspect of the present invention. This may be the first training set of method 200. Training set 100 comprises a plurality of objects, which in the embodiments described below are documents. However, the person skilled in the art will appreciate that other objects can be used in training set 100 depending upon what the AI program to be trained is intended to classify. For example, training set 100 may contain text documents, such as patent documents (i.e. patents and patent applications), or other objects, such as images, sound clips or the like.

The documents of the training set may have certain features or attributes. For example, in the case of patent documents, each document has text associated with it, as well as one or more classification codes and citations. The text may be subdivided into a title, an abstract, a description, and claims. Citations may include references within the document to other patent (or non-patent) documents, and may also include references in a second document back to the first document. Other features of patent documents include bibliographic data, such as assignee, inventor, priority applications, priority/filing/publication/grant dates, jurisdiction and the like. These features or attributes are accessible to a computer program and can be read by a computer program. In particular, these features or attributes may be available in a machine readable format. This allows an AI program to extract common features of different documents and to be trained to classify similar documents as such based upon these features.

Each document in the initial training set 100 may be classified by a human. The documents are classified according to the resultant classification or categorisation that the AI program is intended to give to documents presented to it to classify. For example, in FIG. 1 it is intended that an AI program is to classify a documents as “Positive” or “Negative” and so training set 100 comprises documents that a human has classified as “Positive” or “Negative”. These documents are represented in FIG. 1 by the “Positives” box 102 and the “Negatives” box 104.

In the present case, “Positive” indicates that a document belongs to a particular category. That is, the document is the type of object that the AI is intended to identify when trained, and therefore is of interest to a user or creator. “Negative” indicates that a document does not belong to the particular category, and is not the type of object that the AI is intended to identify when trained, and therefore is not of interest to a user or creator. For example, a user may wish to train an AI program to classify patent documents that relate to a given technology. As such, patents and patent applications that relate to this technology may be classified as “Positive” in the training set 100 because they are of interest to the user and patents and patent applications that do not relate to this technology may be classified as “Negative” in training set 100 because they are not of interest to the user. It is noted that while in the example given only two categories 102 and 104 are shown within training set 100, any number of categories may be present depending upon the intended use of the AI program to be trained. For example, training set 100 may comprise documents classified in four, ten or even one hundred categories.

As indicated above, training set 100 of FIG. 1 may represent the first, initial, training set used in method 200. This may be a small training set, for example comprising ten documents, or another number of documents. These documents may be classified by the user as “Positive” or “Negative” according to whether they are of interest to the user or not of interest to the user.

Alternatively, and particularly for the first iteration of method 200, there are many other ways of generating the first training set. For example, one way of generating the first training set will be using documents that are already known to the user. If the user already has some documents and they are interested in finding documents similar to these using the AI program, they may build the first training set by classifying these documents as “Positive”. Another exemplary way by which a user may build an initial training set is by performing a search. For example, this search could be a text search in relation to the title of documents or in relation to text contained within documents. Alternatively, they may search using classification codes, references, or any other feature of the documents being searched. Typically, one or more databases would be searched. The user is then presented with the results of their search, and a number of documents are classified by the user. These documents then form the first training set. The number of documents in the first training set need not be large. Indeed, the number of documents in the first training set may be only one tenth, one hundredth, one thousandth, or even less, of the number of documents needed for a complete training set. Indeed, one of the aims of embodiments of the present invention is to guide the user from a first training set to a complete training set. It will be appreciated that the skill and effort required by the user to create the first training set is minimal, and that subsequently the user is guided efficiently, without the need for specialist knowledge or decision making, to the creation of a complete training set by the techniques described herein.

Returning to FIG. 2, this Figure shows a computer implemented method 200 of building a complete training set starting from a first training set.

The first training set comprises a number of documents that have been classified as positive or negative. For example, the first training set may be training set 100 illustrated in FIG. 1 comprising documents labelled as “Positives” 102 and “Negatives” 104. These documents have been classified by a user.

As can be seen in FIG. 2, the method 200 is iterative. That is, at step 212 of method 200 it is determined whether the training set is complete. If it is determined that the training set is not complete, the method returns to the first step 202, using the second training set created in step 210 as the new first training set. Therefore, it can be seen that the first training set can be subsequently replaced in the method by the resultant second training set from a previous iteration of method 200 and so on.

The first step 202 of method 200 comprises receiving a selection of a search algorithm for obtaining further documents.

The search algorithm may be selected by a user of the device or automatically from a plurality of preset search algorithms. Automatically selecting the search algorithm allows the method to guide the user completely through the process of building a training set. The only input required from the user is the classification of documents returned by the selected search algorithm.

The automatic selection of the search algorithm may select a search algorithm from a plurality of preset search algorithms. This selection may be configured to return documents expected to be classified as “Positive”, or to return documents expected to be classified as “Negative”. Additionally, or alternatively, this selection may be based on the composition of the first training set. This allows the method to select the optimal search algorithm to best improve the first training set based upon the current composition of the first training set.

Selecting a search algorithm from a plurality of preset search algorithms may comprise determining the number of documents in the training set classified in different classifications and selecting a search algorithm based upon the number of documents in the training set in each classification. For example, regarding the training set 100, the step of selecting a search algorithm from a plurality of preset search algorithms may comprise: determining the number of documents in the training set classified as “Positive” and the number of documents classified as “Negative”; and selecting a search algorithm from a plurality of preset search algorithms based upon the number of documents in the training set classified as “Positive” and the number of documents in the training set classified as “Negative”.

By selecting a search algorithm based upon a determination of the number of documents classified as “Positive” and the number of documents classified as “Negative”, the method guides the user in building up a balanced training set. A balanced training set is one with a similar number of “Positives” as “Negatives”, and is generally the most efficient and effective training set for training an AI program. Alternatively, however, it could be that an unbalanced training set, with more “Positives” than “Negatives” or vice versa could be desired for a specific scenario, and a search algorithm can be selected accordingly. For example, a particular ratio of documents classified as “Positive” or “Negative” may be desired. Therefore, by determining the number of documents in the training set classified as “Positive” and “Negative”, a search algorithm could be selected in order to achieve this ratio. It is noted that a balanced training set can be considered one with approximately a 1:1 ratio of documents classified as “Positive” to documents classified as “Negative”.

In order to achieve a balanced training set, selecting a search algorithm from a plurality of preset search algorithms based upon the number of documents in the training set classified as “Positive” and the number of documents in the training set classified as “Negative” may comprise: selecting, if the number of documents classified as “Positive” in the training set is greater than the number of documents classified as “Negative” in the training set, a search algorithm predetermined to return documents expected to be classified as “Negative”; or, selecting, if the number of documents classified as “Positive” in the training set is less than the number of documents classified as “Negative” in the training set, a search algorithm predetermined to return documents expected to be classified as “Positive”.

In other words, a search algorithm is selected that is predetermined to return documents that are required to balance the number of “Positives” and “Negatives” in the training set. Alternatively, if a different ratio of “Positives” and “Negatives” is desired, an algorithm can be selected that is predetermined to return documents that will help the training set to reach the desired predetermined ratio. By presenting a greater number of documents that are likely to be categorised by the user in a particular way, the chances of arriving at a balanced data set are increased.

Alternatively, or in addition to selecting an algorithm based upon the number of documents in each classification in the training set, a search algorithm may be configured to look at the “breadth” of documents in each classification in the training set. That is, an algorithm may be configured to determine whether there is a good spread of documents in each classification in the training set, and if there is not a good spread, to look for documents that would increase the spread. By “a good spread of documents” it is meant that the documents are representative of the classification.

It may be determined if there is a good spread of documents in a classification in the training set by looking at features of the documents. In particular, one or more of the text of the documents in a classification in the training set, classification codes of documents in a classification in the training set, or citations within or citations of the documents in a classification in the training set may be considered. If each of the documents in the classification in the training set have the same or similar features, it may be considered that there is not a good spread of documents. The algorithm may look for documents that increase the spread of documents in the classification in the training set using methods or techniques described herein, or using other methods or techniques known in the art.

There are different ways by which a search algorithm may be predetermined to return documents expected to be classified in a certain way. One possibility is that each search algorithm in the plurality of preset search algorithms has a predetermined categorisation. This predetermined categorisation can indicate whether the search algorithm is more expected to return documents that will be classified in a given category by the user. This predetermined categorisation may be set by a programmer or developer when programming the computer implemented method 200. In this case, every time that method 200 is performed, and for every user using method 200, each search algorithm will have the same predetermined categorisation.

Alternatively, a search algorithm may be predetermined to return documents expected to be classified a certain way based upon historical data. This historical data may indicate whether the search algorithm returns more documents that were classified in a certain way. For example, each time method 200 is run data may be stored, on a server or other computing device for example, about the search algorithms applied and the categories into which the user classifies the results. For example, if a search algorithm returns five documents, four of which are classified as “Positive” by a user and one of which is classified as “Negative” by the user, data may be stored indicating that the search algorithm returned four “Positives” and one “Negative”. Each search algorithm may then be assigned a category according to which category of documents the search algorithm has returned more of according to the history of the search results stored by server or other computer device. The history of the search results used to assign a category to the search algorithm may comprise only times where the search algorithm has been used in a single use of the method (i.e. during the building of one training set through multiple iterations), or through multiple uses (i.e. cumulating the search results from the use of the method for building a number of different training sets).

The historical data that is captured and stored may include one or more of, but is not limited to, the number of “Positives” returned, the number of “Negatives” returned, and the diversity of the results returned. The diversity of the results returned may refer to the diversity in the user classifications of the results returned, that is, a comparison of the number of “Positives” and the number of “Negatives” returned. Alternatively or additionally, the diversity of the results returned may refer to the diversity of documents returned within a classification. This may be determined in the same or a similar manner to the “spread” of the documents, as discussed previously.

In addition to information about the results returned by an algorithm being stored, predetermined information regarding the context in which an algorithm returned those results may also be stored, and used to determine an algorithm to use. For example, the state of the training set (e.g. one or more of the size of the whole training set, the size of the different classifications within the training set, the diversity of the training set or of classifications within the training set) may be stored when (e.g. each time) an algorithm is run, and this may be associated with information on the results returned by the algorithm. Therefore, an algorithm may be selected based upon both the context and the desired result. For example, the present context may be assessed, and the desired results identified, and then an algorithm may be selected that has obtained the desired results (or similar results) in the same, or a similar, context before. This may be achieved by machine learning techniques.

Alternatively, step 202 of receiving a selection of a search algorithm for obtaining further documents may involve automatically selecting a search algorithm from a plurality of preset search algorithms according to a predefined sequence of the plurality of preset search algorithms. That is, each algorithm is applied in order after a specified previous algorithm was applied in the previous iteration of the method in a cyclical fashion. For example, in the case that the plurality of preset search algorithms includes algorithms a, b, c, and d, these algorithms may be selected and applied in the order a, b, c, d, a, b, c, d, and so on. Alternatively, the order may be different, such as a, c, d, b, or any other order. Applying the algorithms in such an order ensures that each algorithm is applied during the method evenly, meaning that the training set may be more complete than if an algorithm is applied infrequently or never at all.

The selection of an algorithm may involve a mixture of using a predetermined sequence and historical data. For example, if there is no historical data available then a predetermined sequence may be used. Alternatively, a predetermined sequence may be used to select an algorithm for a first number of iterations, and subsequently the algorithm may be selected based upon historical data.

The second step 204 comprises obtaining, based upon the selected algorithm, a plurality of documents.

Step 204 involves performing a search based upon the selected algorithm to return a plurality of documents as results of the search. The search may be performed according to known techniques using one or more databases, or may search a network, such as the internet. Any number of documents may be returned.

The third step 206 comprises presenting a selected subset of the returned documents to a user.

At step 206, a subset of the plurality of documents returned by the search are presented to the user. This subset may include any number of documents. For example, only one document may be selected from the documents returned by the search to be presented to the user, or more than one document may be presented to the user. In an exemplary embodiment, 10 documents are selected from the plurality of documents returned by the search to be presented to the user. If the number of documents returned by the search is less than the number documents that are to be selected to be displayed to the user, then all of the documents returned by the search may be presented to the user.

The fourth step 208 comprises receiving user input, via a GUI, whether one or more of the presented documents are positive or negative. That is, receiving user input, wherein the user input is a user classification of whether one or more of the presented documents are positive or negative.

User input is received at step 208. The user provides a user classification of one or more of the presented documents. The user classification indicates whether the user classifies a document as “Positive” or “Negative”. In some embodiments, the user must classify every document presented to them. Alternatively, in other embodiments, the user may choose to classify only some of the documents presented to them. In either case, the user may also have the option of “discarding” a document—indicating it is not relevant but without adding it to the training set in step 2010.

The fifth step 210 comprises adding the user classified documents to the first training set to create a second training set.

In this step, the documents that were classified by the user in step 208 are added to the training set. The documents classified by the user as “Positive” are added to the training set as “Positives”, for example, they are added to box 102 of training set 100. The documents classified by the user as “Negative” are added to the training set as “Negatives”, for example they are added to box 104 of training set 100. Documents that have not been classified by the user are not added to the training set. Similarly, documents “discarded” by the user are also not added to the training set.

The sixth step 212 comprises determining whether the training set is considered complete. If it is determined that the training set is considered complete, then the method ends 214. Alternatively, if the training set is not considered complete, then the method returns to step 202. The second training set, that includes the documents classified by the user in step 208 and that were added to the first training set in step 210, then takes the place of the first training set, having new user classified documents added to it the next time step 210 is performed, and so on.

The training set may be considered complete in step 212 after a predetermined number of iterations of method 200. For example, the training set may be considered complete after 100 iterations of method 200. That is, steps 202 to 212 would be performed 100 times, and upon the 100th time step 212 is performed the training set would be considered complete and the method would end. It is noted that 100 iterations is an exemplary embodiment, and that fewer or greater iterations could be performed. For example, 10, 50, 200, 1,000 or 10,000 or more iterations could be performed before the training set is considered complete.

Alternatively or additionally, the training set may be considered complete in step 212 when user input is received indicating that the training set is considered complete. In this case, the user may be presented with the option to repeat method 200 again or to finish the method 200. If the user selects to repeat method 200, the method may repeat once more, and present the user with the same options after this subsequent iteration. Alternatively, instead of repeating the method for one further iteration, the method may repeat for a predetermined number of iterations or for a number of iterations selected or input by the user. After these iterations have been finished, the user may be presented with the option to repeat method 200 again or to finish the method 200 again. If the user selects to finish the method 200, the training set may be considered complete and the method may end.

Alternatively or additionally, the training set may be considered complete after each iteration of method 200 is finished unless the user indicates otherwise. For example, the training set may be considered complete unless the user selects to run method 200 for at least one more iteration. For example, the user may be presented with the option to repeat method 200. If the user selects the option to repeat method 200, the method may repeat once more, and present the user with the same option after this subsequent iteration. Alternatively, instead of repeating the method for one further iteration, the method may repeat for a predetermined number of iterations or for a number of iterations selected or input by the user. However, unless the user selects the option of repeating the iteration, the training set may be considered complete.

The user may decide to finish the method 200 when they can no longer detect that the AI classifier program trained on the training set 100 is making mistakes. For example, the option to test the AI program may be presented to the user. This may cause the AI program to classify a number of documents (which may be a predetermined number or a number selected by the user). The user may then inspect the classification to determine if the AI program has made any mistakes, and based upon this assessment may determine whether the training set 100 is complete. Additionally, other techniques known to the skilled person, such as “cross validation” techniques, can be used to determine, or assist the user to determine, whether the training set 100 is considered complete.

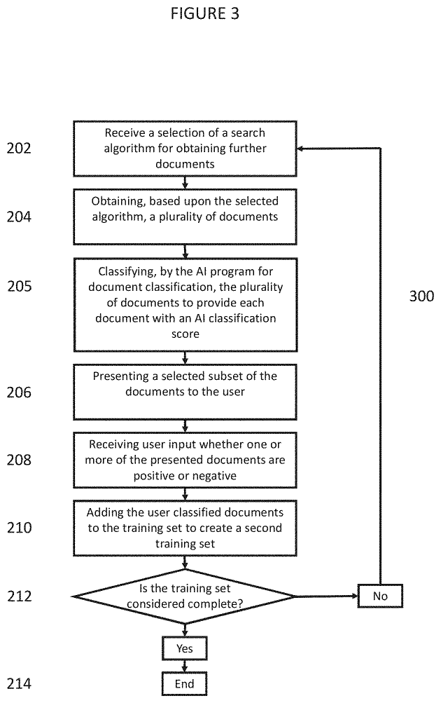

FIG. 3 shows another embodiment of method 300. In this embodiment, method 300 is identical to method 200 except for the inclusion of step 205 of classifying, by the AI program for document classification, the plurality of documents to provide each document with an AI classification score indicating whether the AI program classifies each document as positive or negative, the AI classification score being a numerical score within a numerical range having an upper and a lower bound.

In this step, the AI program, currently trained upon the documents that are presently in the training set, performs a classification of each document of the plurality of documents that are obtained in step 204 using the search algorithm selected in step 202. The result of the classification is that each document is assigned a score. This may be a numerical score, and in the present embodiment is a numerical value within the range 0 to 1. In the present embodiment a score of 0 may indicate a classification of “Negative” and a score of 1 may indicate a classification of “Positive”.

Specifically, a score of 0 may indicate that the AI program is certain that a document should be classified as “Negative” while a score of 1 may indicate that the AI program is certain that a document should be classified as “Positive”. Scores between 0 and 1 represent the uncertainty of the AI program. A score of 0.5 may indicate that the AI program is uncertain whether a document should be classified as “Positive” or “Negative”, while a score between 0 and 0.5 or 0.5 and 1 may indicate that the AI program thinks that a document should be classified as “Negative” or “Positive” respectively but is not certain of this classification. The closer a score is to 0.5, the more uncertain the AI program may be. Conversely, the closer the score is to 0 or 1 the more certain the AI program may be. This type of classifier scoring may be performed according to known techniques employed by classifier algorithms, and is sometimes described as a probability.

In this embodiment, it is also noted that the user may use the AI classification scores to determine whether they consider the AI program to be making mistakes and hence to determine whether the training set 100 is considered complete. Furthermore, it is noted that the user classification of step 208 may be considered equivalent to an assignment of a score of 1 or 0 by the user in the case that the user classifies a document as “Positive” or “Negative” respectively.

In the present embodiment there are only two categories, and so a single number can be used to represent a classification into these categories. However, in the case where there are more than two categories, multiple numbers may be used. For example, these numbers may take a vector form. Each category may be assigned one number. For example, if there are three categories then each document may be assigned a vector (x, y, z). Each number may be between 0 and 1 and represent the confidence of the AI program that the document belongs in each category. For example, a score of 0 may indicate that the AI program is certain that a document does not belong in a category, while a score of 1 may indicate that the AI program is certain that a document does belong in a category.

The AI classification score that is given to each document by the AI program in step 205 can be used to help improve the efficiency of creating a training set. For example, the AI classification scores can be used to determine when the training set is incomplete, and what types of documents are needed to make the training set more complete.

In one embodiment, the selected subset of documents that are presented to the user in step 206 can be based upon the AI classification score assigned to each document in step 205. For example, the selected subset of the documents presented to the user may comprise documents assigned a range of AI classification scores by the AI program. In particular, the range of scores of the documents presented to the user may be distributed across substantially the entire numerical range of the AI classification score.

One way of selecting scores distributed across a range of scores may be to select the document with the highest score, the document with the lowest score, and a number of documents with scores as evenly spaced between the highest score and the lowest score as possible. For example, if 10 documents are to be selected, and the highest score is 0.75 and the lowest score is 0.3, documents that have scores closest to 0.35, 0.4, 0.45, 0.5, 0.55, 0.6, 0.65, and 0.7 may be selected, in addition to the documents with scores 0.3 and 0.75. However, this example is not intended to be limiting and other rules for selecting a range of scores distributed substantially across the range of AI classification scores are contemplated.

Another way that the selected subset of documents that are presented to the user can be based on the AI classification score is that the selected subset of documents presented to the user comprise documents assigned an AI classification score within a predetermined range indicating that the AI program is not confident in its classification of whether the document is positive or negative. In the present embodiment which assigns a score between 0 and 1 to a document, this would mean selecting documents with an AI classification score of around 0.5. The predetermined range may be, for example, 0.5±0.1. In this case, the method will select documents with an AI classification score between 0.4 and 0.6. In some embodiments, there may be numerous predetermined ranges, with a rule for selecting the predetermined range. For example, if 10 documents are to be selected, and there are not 10 documents with scores within the range 0.5±0.1, then the range may be increased to 0.5±0.2. If there are still not 10 documents within this range then the range may be increased again to 0.5±0.3, and so on. Selecting documents in such a way advantageously provides a spread of documents for the user to classify and to therefore be added to the training set. This increases the likelihood that the documents added to the training set will provide a more complete training set.

In another embodiment, the predetermined range may be based not on the specific numerical values, but instead upon the number of documents above and below the central value. For example, the method may be configured to obtain five documents with a score above 0.5 and five documents with a score below 0.5. In particular, the five documents with a score closest to 0.5 may be selected from each of the documents having a score above 0.5 and the documents having a score of below 0.5. The range is thus predetermined in that it is predetermined how many documents with a score above and below 0.5 will be selected. This may lead to an asymmetric numerical range. By selecting documents for which the AI program is unsure how to classify, the efficiency of building the training set can be increased. This is because the AI program identifies areas where it is weakest, and provides documents that fall within these areas to be presented to the user for classification and hence addition to the training set.

A combination of the above methods of selecting documents to be presented to the user can be implemented. For example, the method may alternate between each of the two above methods between each iteration of the method 300. Alternatively, the methods could be combined. For example, a broad range of documents could be presented, but with a weighting to select documents that the AI program is unsure how to classify. For example, if 10 documents are to be selected, 6 documents could be selected in the range 0.5±0.1, and four documents could be selected with scores outside of this range. This combines the benefits of both approaches, by focusing on areas that the AI program is not yet good at classifying, but also allowing the user to check that areas that the AI program thinks it is classifying correctly are in fact being classified correctly.

It is noted that the specific numerical ranges given are exemplary, and it is anticipated that others may be selected. Additionally, in other embodiments a value other than 0.5 may represent the most uncertainty in the classification by the AI program. That is, other values may be taken to represent the threshold between classifications. The skilled person may select an appropriate threshold for the specific implementation they require. Alternatively, in some embodiments, the search algorithm used may be configured to select an appropriate threshold.

Step 202 in both method 200 and method 300 involves receiving a selection of a search algorithm for obtaining further documents. The search algorithm may be selected from a plurality of predefined search algorithms.

In one embodiment of the present invention, at least one of the plurality of preset search algorithms is an algorithm configured to return documents based upon one or more of the text of the documents in the training set, classification codes of documents in the training set, or citations within or citations of the documents in the training set. That is, at least one search algorithm of the plurality of preset search algorithms is configured to perform a search based upon one or more of the text of the documents in the training set, classification codes of documents in the training set, or citations within or citations of the documents in the training set.

An algorithm configured to perform a search based upon the text of a document may be configured to look for documents that contain certain words or phrases within the whole text of the document, or a specific portion of a document. For example, in the case that the documents are patents or patent applications, an algorithm may be configured to perform a text search of just the claims, or the claims and the abstract, or the claims, abstract and title, or the whole document. Well known search techniques can be used, including Boolean operators, such as AND, OR and NOT, as well as semantic searching and wildcard searching, to name but a few. The present disclosure is not limited in this regard.

Such text search algorithms can be configured to return documents likely to be classified in a certain category. An algorithm can be configured to identify words that appear frequently within documents in the different categories of the training set and infrequently within documents in the different categories of the training set. By using these words, along with appropriate Boolean operators, documents can be returned that are likely to be classified in a specific category. For example, documents within the “Positives” may frequently contain a first word, while documents within the “Negatives” may frequently contain a second word. Therefore, to find documents likely to be classifies as “Positive”, an algorithm may be configured to search for documents containing the first word but not the second word.

In such a way, an algorithm can be configured to look for text that is similar to documents classified as “Positive”, and thus be more likely to return documents that the user will classify as “Positive”. Alternatively, an algorithm can be configured to look for text that is similar to documents classified as “Negative”, and thus be more likely to return documents that the user will classify as “Negative”. It is also possible, as explained above, for an algorithm to look for documents that are both similar to documents classified as “Positive” and dissimilar to documents classified as “Negative”, and vice versa.

In addition, an algorithm can be configured to look for documents that are similar or dissimilar to specific documents within each category of the training set using a text search. For example, in order to return documents likely to be classified as “Positive”, a text search algorithm may be configured to return documents similar to the document classified as “Positive” with the lowest AI classification score in the training set. Alternatively, a text search algorithm may be configured to return documents similar to the documents classified as “Negative” with the highest AI classification score in the training set. Such algorithms could be advantageous, because such documents can indicate an area of technology or type of document that the AI program is not confident at classifying, and so identifying these documents can help to efficiently expand the training set.

An algorithm configured to perform a search based upon the classification codes of a document may be configured to look for documents with certain classifications. For example, in the case that the documents are patents or patent applications, an algorithm may be configured to look for documents with certain International Patent Classification (IPC) codes, Cooperative Patent Classification (CPC) codes, or United States Patent Classification (USPC) codes, for example. Well known search techniques can be used, including Boolean operators, such as AND, OR and NOT, as well as other techniques such as wildcard searching. The present disclosure is not limited in this regard.

Searching for documents based upon classification codes can be advantageous as it can allow similar documents to be found regardless of the language used in the document. For example, such an algorithm may be able to identify two documents that relate to the same concept even if they use synonyms and so have little overlapping text. An algorithm may be configured to look for documents with the same classification codes, or combinations of classification codes, as documents within the training set, or within one category within the training set. In particular, an algorithm may be configured to look for documents with the combination of classification codes that occurs most or least frequently in documents within a certain category within the training set. For example, an algorithm may be configured to look for documents with the most common combination of two classification codes for documents within the “Positives” category within the training set. This may return documents that are likely to be classified as “Positive”. Alternatively, for example, an algorithm may be configured to look for documents with the least common combination of two classification codes for documents within the “Positives” category within the training set. This infrequent combination of classification codes may represent an area not well represented in the “Positives” that would otherwise be overlooked, and may therefore return documents that are more likely to be classified as “Negative”. Hence, by finding documents with these classification codes the training set may be made more complete.

Such algorithms, by using increasingly less common combinations of classification codes (when looking for “Positives”) or more common combinations of classification codes (when looking for “Negatives”) in subsequent iterations of the method, the “edge” of a category into which the AI program is to classify documents can be identified. That is documents that belong in one category, but that are more and more similar to those of another category, will be returned by the algorithms so that the AI program can be fine-tuned and learn the difference between closely related documents that nevertheless belong in different categories.

An algorithm configured to perform a search based upon citations within documents in the training set may be configured to identify times that a document within a category within the training set references or cites another document. It will be noted that this need not be a direct reference or citation, but may frequently be a second, third or higher order link. Accordingly, the most commonly cited documents within each category may be identified. A search may be performed looking for other documents not already within the training set that also cite these most commonly cited documents within each category. In particular, documents that are frequently cited by documents in one category but infrequently cited by documents in another category can be identified.

By searching for documents that cite the most commonly cited documents within a given category, other documents likely to be classified within that category can be identified. This is especially the case if documents citing documents that are cited frequently by documents in one category but infrequently by documents in another category are searched for. For example, if many of the documents in the “Positives” cite document X, and few documents in the “Negatives” cite document X, then by looking for other documents that cite document X, documents that are likely to be classified as “Positive” may be returned.

Alternatively, or in addition, an algorithm configured to perform a search based upon citations within documents in the training set may be configured to look for documents that cite or reference documents already in the training set but with degrees of separation greater than one. That is, two documents may be linked by a chain of documents that cite or reference each other. The degree of separation may reflect how many documents are between two given documents in this chain. A document that directly cites another would be a first order citation, or one degree of separation between the two documents. A first document, which cites a second document, which itself cites a third document would give a second order citation, or two degrees of separation between the first and third documents. The first and last documents in a chain of n documents (including the first and last documents) would have a degree of separation of n−1, or could be considered to be (n−1)th order citations. It will be appreciated that an algorithm may be configured to look for documents with any degree of separation, including, but not limited to 1 degree of separation, 2 degrees of separation, 3 degrees of separation, 5 degrees of separation and 10 degrees of separation. Additionally, during subsequent iterations of the method, an algorithm may be configured to change the degree of separation. For example, an algorithm may be configured to increase the degree of separation that is considered during subsequent iterations, or an algorithm may be configured to decrease the degree of separation that is considered during subsequent iterations. The increment in the degree of separation considered from one iteration to another may be one, or may be more than one. Additionally, the increment in the degree of separation may be constant, or it may increase or decrease, between iterations. Additionally, the degree of separation considered may switch between a high degree of separation and a low degree of separation and back between iterations.

By searching for documents that have a given degree of separation, an algorithm may be likely to find documents that are reasonably similar to a document in a category in the training set, but that may be classified differently by the user. This can be advantageous as it can help to identify the “edge” of the category, that is, it can help to find the documents that are closest to documents within a category and yet are not that category themselves. In particular, by incrementing the degree of separation between iterations, an algorithm can “scan” until the edge of the category is found. For example, with one degree of separation from a document X, it may be likely that the documents returned by the algorithm will be in the same category as document X. With three degrees of separation, it may be likely that some of the documents returned by the algorithm will be in the same category as document X, while others may not. With five degrees of separation, it may be likely that most of the documents returned by the algorithm will not be in the same category as document X, and that only some will be. Therefore, it can be determined that documents with three degrees of separation often lie around the boundary of the category. Such a technique can help to expand the training set in an efficient way by returning documents that will usefully expand the training set, rather than documents that can already easily be classified into one category or another in the training set. That is, borderline cases can be found which efficiently expend the training set.

By way of an example, if a document X is in the “Positives”, by looking for documents with degrees of separation of greater than one, (e.g. three or four degrees of separation) it may be possible to find documents that are reasonably similar to document X, but are beyond the “edge” of the “Positives” category and will instead belong in the “Negatives” category. Therefore, when starting with a document classified as “Positive”, an algorithm may be configured to return documents likely to be classified as “Negative”, and vice versa.

Similarly, an algorithm may be configured to perform a search based upon citations of documents within the training set. That is, an algorithm may be configured to return documents that cite documents within the training set, or more specifically documents within a category within the training set. The algorithm may be configured to return the documents that cite the greatest number of documents within a category of the training set. Such an algorithm can help to find related documents to those already in the training set.

In the same or a different embodiment, at least one of the plurality of preset search algorithms may be an algorithm configured to return documents that are similar to documents that have been classified differently by the user and the AI program.

A document has been classified differently when the AI program assigns a document an AI classifier score in step 205 that is different from the classification that the user gives to the document in step 208. For example, if the user classifies a document as “Positive” but the AI program assigned that document an AI classifier score of less than 0.5, then the document has been classified differently by the AI program and the user. Similarly, if the user classifies a document as “Negative” but the AI program assigned that document an AI classified score of greater than 0.5, then the document has been classified differently by the AI program and the user. Documents similar to those classified differently by the AI program and the user can be found using any of the suitable above methods. For example, an algorithm may be configured to return documents based upon a text search which could be performed looking for documents containing words, phrases, or a combination thereof that appear or appear frequently in documents classified differently. Additionally or alternatively, an algorithm could be configured to return documents based upon a classification search which could be performed looking for documents classified with the same combination of classification codes that occur or occur frequently in documents classified differently.

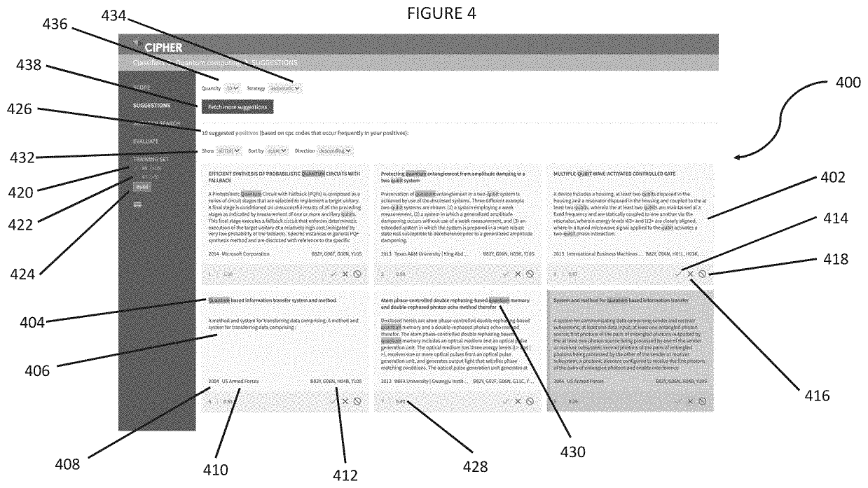

Methods 200 and 300 require input from the user at least at step 208. The user input may be obtained through an interface of a computing device. This user interface may be a graphical user interface. The steps of method 200 and method 300 may take place within a single user interface environment. The results of each step may be indicated or displayed to the user through this single user interface environment. FIG. 4 shows an example user interface environment 400 in which the method of FIG. 2 and/or FIG. 3 may be performed.

The interface 400 has a number of features. Primarily, a number of documents are presented in boxes 402. In this example, these documents are patent documents. That is, the documents are patents or patent applications. For each document, some information is displayed to the user. This enables the user to quickly and easily classify the document in step 208. In the embodiment of FIG. 4, a title 404 and abstract 406 are shown. In addition, some bibliographic data is also shown, including a publication date 408, an applicant or proprietor 410, and classification codes 412. It is noted that the specific information displayed for each document in FIG. 4 is exemplary, and other information may be shown as well as, or instead of, some or all of the information shown in FIG. 4. In particular, the information shown may be dependent upon the type of the documents being displayed.

As well as a number of items of information being displayed for each document, each document is provided with means for the user to classify each document. In the embodiment of FIG. 4, each document is provided with a “Positive” button 414 for indicating that the document is of interest and belongs in the “Positives” in the training set, a “Negative” button 416 for indicating that the document is not of interest and belongs in the “Negatives” in the training set, and a “Discard” button 418 indicating that the document should be “discarded” without being put into the “Positives” or the “Negatives” within the training set.

According to any embodiment information about the current state of the training set may be displayed to the user in interface 400. Specifically, information about the size of the “Positives” 420 is displayed, indicating how many documents are currently in the “Positives” class in the training set, as well as how many documents the user has selected as being “Positive” to add to the “Positives” in the training set. Likewise, information about the size of the “Negatives” 422 is displayed, indicating how many documents are currently in the “Negatives” class in the training set, as well as how many documents the user has selected as being “Negative” to add to the “Negatives” in the training set. A means for adding the documents classified by the user to the training set is provided by button 424, though this button may not be present in all embodiments and in some embodiments the documents classified by the user may be automatically added to the training set.

Interface 400 may also provide information on the algorithm used 426 to obtain the documents presented to the user, as well as indicating an AI classification score 428 (in the case of method 300) assigned by the AI program for each document. Furthermore, in this example, words are optionally highlighted 430 that are relevant to the search algorithm used. For example, words that were searched for may be highlighted, or words that appear frequently in documents of interest in the “Positives” may be highlighted, even if the search algorithm was not looking for these words. Highlighting certain words in such a manner may assist the user in determining whether a document is of interest or not and hence may assist the user in classifying the documents. However, in some embodiments no words are highlighted.

The user is presented with options in boxes 432 to select how the documents are displayed. For example, the number of documents to be displayed can be selected, as well as the order in which the documents are displayed. If all of the documents cannot be displayed on the screen of the device displaying interface 400, then the user may scroll through the documents, or browse through different pages of documents.

Box 434 allows the user to select the strategy used to select an algorithm, obtain documents, and then select and present documents to the user. For example, in FIG. 4, box 434 is set to automatic indicating that the search algorithm is automatically selected. This may be done in any of the ways previously discussed in this application. Alternatively, the user may select a specific algorithm that they wish to be applied. If the user clicks box 434, they may be presented with the plurality of search algorithms. When presented with the plurality of search algorithms that the user may select from, or that may automatically be selected from, a list or other arrangement of algorithms may be presented to the user. The algorithms may be presented to the user grouped according to whether they are likely to return documents expected to be classified as “Positive” by the user or likely to return documents expected to be classified as “Negative” by the user. Additionally or alternatively, other methods of grouping the algorithms for display may be used, such as the type of algorithm (text search, classification code, citations etc.). Box 436 allows the user to select how many documents they would like to have presented to them, and in FIG. 4 this number is set to 10. However, it is understood that the user may select a larger or smaller number of documents to be displayed.

The interface 400 of FIG. 4 also provides a means for the user to repeat the method (200 or 300 depending upon the embodiment) in the form of button 436. If the user selects button 438, then the method will repeat and present new documents to the user. As previously discussed in relation to step 212 of method 200, the training set may be considered complete and the method may end unless the user selects button 436.

1. A computer implemented method of building a training set for training an AI program for document classification, the method comprising, in relation to a first training set comprising a set of documents classified as positive, and therefore assigned to a first category, or negative, and therefore not assigned to the first category, the following steps:
receiving a selection of a search algorithm for obtaining further documents;
obtaining, based upon the selected algorithm, a plurality of documents;
presenting a selected subset of the documents to the user;
receiving user input, wherein the user input is a user classification of whether one or more of the presented documents are positive or negative;
adding the user classified documents to the training set to create a second training set; and
repeating, until the training set is considered complete, the above steps, wherein the second training set is then used as the first training set.

2. The method of claim 1, wherein the step of receiving a selection of a search algorithm for obtaining further documents comprises the step of automatically selecting a search algorithm from a plurality of preset search algorithms.

3. The method of claim 2, wherein the search algorithm is automatically selected from a plurality of preset search algorithms based on the composition of the first training set.

4. The method of claim 3, wherein automatically selecting, based upon the composition of the first training set, an algorithm from a plurality of preset search algorithms comprises:
determining the number of documents in the training set classified as positive and the number of documents in the training set classified as negative in the training set; and
selecting a search algorithm from a plurality of preset search algorithms based upon the number of documents in the training set classified as positive and the number of documents in the training set classified as negative.

5. The method of claim 4, wherein selecting a search algorithm from a plurality of preset search algorithms based upon the number of documents in the training set classified as positive and the number of documents in the training set classified as negative comprises:
selecting, if the number of documents classified as positive in the training set is greater than the number of documents classified as negative in the training set, a search algorithm predetermined to return documents expected to be classified as negative; or
selecting, if the number of documents classified as positive in the training set is less than the number of documents classified as negative in the training set, a search algorithm predetermined to return documents expected to be classified as positive.

6. The method of claim 5, wherein a search algorithm is predetermined to return documents expected to be classified as negative or positive based upon a predetermined categorisation of the search algorithm.

7. The method of claim 5, wherein a search algorithm is predetermined to return documents expected to be classified as negative or positive based upon historical data indicating whether the search algorithm returns more documents that were classified as negative or positive.

8. The method of claim 2, wherein the search algorithm is automatically selected from a plurality of preset search algorithms according to a predefined sequence of the plurality of preset search algorithms.

9. The method of claim 1, wherein the method further comprises, between the step of obtaining, based upon the selected algorithm, a plurality of documents and the step of presenting a selected subset of the documents to the user, the step of:
classifying, by the AI program for document classification, the plurality of documents to provide each document with an AI classification score indicating whether the AI program classifies each document as positive or negative, the AI classification score being a numerical score within a numerical range having an upper and a lower bound.

10. The method of claim 9, wherein the selected subset of the documents presented to the user comprise documents assigned a range of AI classification scores by the AI program, the range of scores being distributed across substantially the entire numerical range of the AI classification score.

11. The method of claim 9, wherein the selected subset of the documents presented to the user comprise documents assigned an AI classification score within a predetermined range indicating that the AI program is not confident in its classification of whether the document is positive or negative.

12. The method of claim 1, wherein at least one of the plurality of preset search algorithms is an algorithm configured to return documents based upon one or more of the text of the documents in the training set, classification codes of documents in the training set, or citations within or citations of the documents in the training set.

13. The method of claim 12, wherein at least one of the plurality of preset search algorithms is an algorithm configured to return documents based upon synonyms of words that the AI program has determined are relevant.

14. The method of claim 13, wherein words are determined to be relevant by the AI program if they occur frequently in documents classified by the user as positive but infrequently in documents classified as negative by the user.

15. The method of claim 12, wherein at least one of the plurality of preset search algorithms is an algorithm configured to return documents that are similar to documents that have been classified differently both by the user and the AI program.

16. The method of claim 12, wherein at least one of the plurality of preset search algorithms is an algorithm configured to return documents that are associated with classification codes that are frequently associated with documents classified as positive within the training set.

17. The method of claim 12, wherein at least one of the plurality of preset search algorithms is an algorithm configured to return documents that are associated with classification codes that are infrequently associated with documents classified as positive within the training set.

18. The method of claim 1, wherein the training set is considered complete either after a predetermined number iterations or when user input is received indicating that the training set is considered complete.

19. The method of claim 1, wherein the steps of the method take place in a single user interface environment.

20. The method of claim 1, wherein the number of documents classified as positive and the number of documents classified as negative in the first training set are displayed to the user.

21. A computer program comprising instructions which when implemented upon a computer device cause the computer device to carry out the method of claim 1.

22. A device comprising a memory, wherein the memory has stored upon it a computer program according to claim 21.

23. A training set for an AI program for document classification built using the method of claim 1.

24. A device comprising a memory, wherein the memory has stored upon it a training set according to claim 23.

25. An AI program for document classification trained using a training set built using the method of claim 1.

26. A device comprising a memory, wherein the memory has stored upon it an AI program according to claim 25.
